(19) United States
(12) Patent Application Publication
(10) Pub. No.: US 2024/0332491 A1
(43) Pub. Date: Oct. 3, 2024

(54) METHOD OF MANUFACTURING ALL SOLID-STATE SECONDARY BATTERY

(71) Applicant: HONDA MOTOR CO., LTD., Tokyo (JP)

(72) Inventors: Hiroki Ichihara, Wako-shi (JP); Takashi Toyoshima, Wako-shi (JP); Yohei Noji, Wako-shi (JP); Kosei Miyata, Wako-shi (JP)

(21) Appl. No.: 18/585,096

(22) Filed: Feb. 23, 2024

(30) Foreign Application Priority Data
Mar. 29, 2023 (JP) 2023-052751

(51) Int. Cl. H01M 4/04; H01M 4/62; H01M 10/0585

(52) U.S. Cl. CPC H01M 4/0435; H01M 4/621; H01M 10/0585; H01M 2300/0065

(57) ABSTRACT

A method of manufacturing an all solid-state secondary battery includes a positive electrode layer forming process, a first compression process, an electrolyte layer laminating process, a second compression process, an intermediate layer laminating process, a third compression process, an integrating process, and a fourth compression process. A second pressure in the second compression process is higher than each of a first pressure in the first compression process, a third pressure in the third compression process, and a fourth pressure in the fourth compression process.

### CROSS-REFERENCE TO RELATED APPLICATION

Priority is claimed on Japanese Patent Application No. 2023-052751, filed Mar. 29, 2023, the content of which is incorporated herein by reference.

### BACKGROUND OF THE INVENTION

### Field of the Invention

The present invention relates to a method of manufacturing an all solid-state secondary battery.

### Description of Related Art

In recent years, research and development of secondary batteries that contribute to energy efficiency has been underway to ensure that more people have access to affordable, reliable, sustainable, and advanced energy. Among secondary batteries, all solid-state secondary batteries are attracting attention because of their excellent characteristics in terms of safety, longevity, output, and the like. As a method of manufacturing an all solid-state secondary battery, a method of pressing a laminated body constituted by a positive electrode layer, a solid electrolyte, and a negative electrode layer is known (for example, see Japanese Patent No. 6251974).

### SUMMARY OF THE INVENTION

Incidentally, in technology related to secondary batteries, the challenge is to obtain homogeneity for all solid-state batteries.

An aspect of the present invention is directed to accomplishing a method of manufacturing an all solid-state secondary battery with excellent homogeneity. This contributes to energy efficiency.

An aspect of the present invention provides the following configurations.

A method of manufacturing an all solid-state secondary battery according to an aspect of the present invention includes a positive electrode layer forming process of forming a positive electrode layer containing a positive electrode active material; a first compression process of compressing the positive electrode layer with a first pressure and obtaining a first compressed body; an electrolyte layer laminating process of laminating an electrolyte layer containing a solid electrolyte on a surface of the first compressed body in which the positive electrode layer is exposed; a second compression process of compressing the positive electrode layer and the electrolyte layer with a second pressure and obtaining a second compressed body; an intermediate layer laminating process of preparing a negative electrode layer and an intermediate layer and laminating the intermediate layer on the negative electrode layer; a third compression process of compressing the negative electrode layer and the intermediate layer with a third pressure and obtaining a third compressed body; an integrating process of obtaining an integrated member by integrating the second compressed body and the third compressed body such that the electrolyte layer of the second compressed body faces the intermediate layer of the third compressed body; and a fourth compression process of compressing the integrated member with a fourth pressure. The second pressure is higher than each of the first pressure, the third pressure, and the fourth pressure.

According to this method, by performing the first compression process, the positive electrode layer can be preliminarily compressed. Accordingly, it is possible to promote alignment of particles that configure the positive electrode layer. For this reason, a positive electrode density in the positive electrode layer can be easily stabilized.

By performing the second compression process, a density of the positive electrode layer can be increased while a bonding property between the positive electrode layer and the electrolyte layer is improved.

By performing the third compression process, the intermediate layer can be densified while damage to the negative electrode layer is suppressed.

By performing the fourth compression process, the second compressed body and the third compressed body that constitute the integrated member can be bonded to each other.

Further, since smoothness in an interface between the electrolyte layer and the intermediate layer is improved, it is possible to realize the all solid-state secondary battery with excellent homogeneity.

In the method of manufacturing an all solid-state secondary battery according to the aspect of the present invention, in the positive electrode layer forming process, a positive electrode current collector having a first surface and a second surface opposite to the first surface may be prepared, and the positive electrode layer may be formed on each of the first surface and the second surface.

According to this method, the positive electrode layer is formed on the first surface of the positive electrode current collector. Similarly, the positive electrode layer is formed on the second surface of the positive electrode current collector. That is, a structure in which the positive electrode layer is formed on both surfaces of the positive electrode current collector is obtained. In such a structure, even after the first compression process, the second compression process, the third compression process, and the fourth compression process are performed, a restoring force of the positive electrode layer generated in the first surface and a restoring force of the positive electrode layer generated in the second surface cancel each other out. Accordingly, in the entire all solid-state secondary battery, occurrence of warpage is suppressed. For this reason, flatness of the all solid-state secondary battery can be improved. In particular, in the first compression process, the second compression process, the third compression process, and the fourth compression process, when the roll press method is used, a difference in frictional coefficient between the surface of the roll and the surface of the laminated body laminated on both surfaces of the positive electrode current collector can be reduced. Accordingly, flatness of the all solid-state secondary battery can be improved.

In the method of manufacturing an all solid-state secondary battery according to the aspect of the present invention, the intermediate layer may have a solid electrolyte, a carbide, and a binder.

In general, the electrolyte layer is composed of a powder. For this reason, in a structure in which the electrolyte layer is directly bonded to the negative electrode layer, a bonding property of the negative electrode layer to the electrolyte layer is low. On the other hand, in the method of manufacturing an all solid-state secondary battery according to the aspect of the present invention, the intermediate layer is interposed between the negative electrode layer and the electrolyte layer, and the intermediate layer has a solid electrolyte, a carbide, and a binder. Accordingly, in comparison with the structure in which the electrolyte layer is directly bonded to the negative electrode layer, in a structure including the intermediate layer, a bonding property of the negative electrode layer to the electrolyte layer can be increased.

Further, the intermediate layer is compressed with the third pressure lower than the second pressure, and compressed with the fourth pressure lower than the second pressure. For this reason, it is possible to suppress segregation in the particles that compose the solid electrolyte, the carbide, and the binder contained in the intermediate layer.

In the method of manufacturing an all solid-state secondary battery according to the aspect of the present invention, in each of the first compression process, the second compression process, the third compression process, and the fourth compression process, a compression member configured to compress a compression object may be used, and in at least one of the first compression process, the second compression process, the third compression process, and the fourth compression process, the compression member may compress the compression object in a state in which a protective sheet is interposed between the compression object and the compression member.

According to this method, at least one of the first compression process, the second compression process, the third compression process and the fourth compression process is performed using the protective sheet. Accordingly, even when the pressure is added to the layers that constitute the all solid-state secondary battery, damage to the layers can be suppressed. Here, the layers that constitute the all solid-state secondary battery are, for example, the positive electrode current collector, the negative electrode layer, the negative electrode current collector, and the like. In particular, when the layers that constitute the all solid-state secondary battery are formed of a thin foil-shaped material, an effect of suppressing damage to the layers can be obtained.

In the method of manufacturing an all solid-state secondary battery according to the aspect of the present invention, a thin film electrolyte layer which contains a solid electrolyte and which is thinner than the electrolyte layer may be prepared, after the third compression process is performed, the thin film electrolyte layer may be laminated on a surface of the third compressed body in which the intermediate layer is exposed, and in the integrating process, the integrated member may be obtained by integrating the second compressed body and the third compressed body so as to sandwich the thin film electrolyte layer.

In the method of manufacturing an all solid-state secondary battery according to the aspect of the present invention, a thin film electrolyte layer which contains a solid electrolyte and which is thinner than the electrolyte layer may be prepared, after the second compression process is performed, the thin film electrolyte layer may be laminated on a surface of the second compressed body in which the electrolyte layer is exposed, and in the integrating process, the integrated member may be obtained by integrating the second compressed body and the third compressed body so as to sandwich the thin film electrolyte layer.

According to this method, before the fourth compression process is performed, an uneven shape of the thin film electrolyte layer can be maintained, and a low density state can be maintained. Further, the thin film electrolyte can function as an adhesive agent that makes the second compressed body and the third compressed body adhere to each other in the fourth compression process.

In the method of manufacturing an all solid-state secondary battery according to the aspect of the present invention, the electrolyte layer may have a porous substrate.

According to this method, when the electrolyte layer is thin, even though the electrolyte layer is compressed at the second pressure in the second compression process, dimensional accuracy of the electrolyte layer can be maintained.

According to the method of manufacturing an all solid-state secondary battery of the aspect of the present invention, it is possible to provide a method of manufacturing an all solid-state secondary battery with excellent homogeneity.

### BRIEF DESCRIPTION OF THE DRAWINGS

FIG. 1 is cross-sectional view partially showing a structure of an all solid-state secondary battery according to a first embodiment of the present invention.

FIG. 2 is a cross-sectional view showing a part of a roll press apparatus, describing a roll press method in manufacturing of the all solid-state secondary battery according to the first embodiment of the present invention.

FIG. 3 is a cross-sectional view partially showing a structure of a first compressed body obtained in the middle of the manufacture, describing a method of manufacturing the all solid-state secondary battery according to the first embodiment of the present invention.

FIG. 4 is a cross-sectional view partially showing a structure of a second compressed body obtained in the middle of the manufacture, describing the method of manufacturing the all solid-state secondary battery according to the first embodiment of the present invention.

FIG. 5 is a cross-sectional view partially showing a structure of a third compressed body obtained in the middle of the manufacture, describing the method of manufacturing the all solid-state secondary battery according to the first embodiment of the present invention.

FIG. 6 is a cross-sectional view partially showing a structure of an all solid-state secondary battery according to a second embodiment of the present invention.

FIG. 7 is a cross-sectional view partially showing a structure of a first compressed body obtained in the middle of the manufacture, describing a method of manufacturing an all solid-state secondary battery according to the second embodiment of the present invention.

FIG. 8 is a cross-sectional view partially showing a structure of a second compressed body obtained in the middle of the manufacture, describing the method of manufacturing an all solid-state secondary battery according to the second embodiment of the present invention.

FIG. 9 is a cross-sectional view partially showing a structure of a third compressed body obtained in the middle of the manufacture, describing the method of manufacturing an all solid-state secondary battery according to the second embodiment of the present invention.

FIG. 10 is a cross-sectional view partially showing a structure of a second compressed body obtained in the middle of the manufacture, describing a method of manufacturing an all solid-state secondary battery according to a third embodiment of the present invention.

FIG. 11 is a cross-sectional view partially showing a structure of a third compressed body obtained in the middle of the manufacture, describing the method of manufacturing an all solid-state secondary battery according to the third embodiment of the present invention.

FIG. 12 is a cross-sectional view showing a part of a roll press apparatus, describing a roll press method used in manufacturing an all solid-state secondary battery according to a fifth embodiment of the present invention.

### DETAILED DESCRIPTION OF THE INVENTION

A method of manufacturing an all solid-state secondary battery according to an embodiment of the present invention will be described with reference to the accompanying drawings.

In the drawings used in the following description, in order to make each member recognizable, the scale of each member is changed as appropriate.

The meaning of the word “lamination” is not limited to forming a layer on an object member, but includes pre-forming a layer and transferring this layer onto an object member.

The meaning of the word “facing” is not limited to a case in which two members face to come into contact with each other, and includes a case in which two members face each other with a member interposed between the two members.

### First Embodiment

### <Configuration of all Solid-State Secondary Battery>

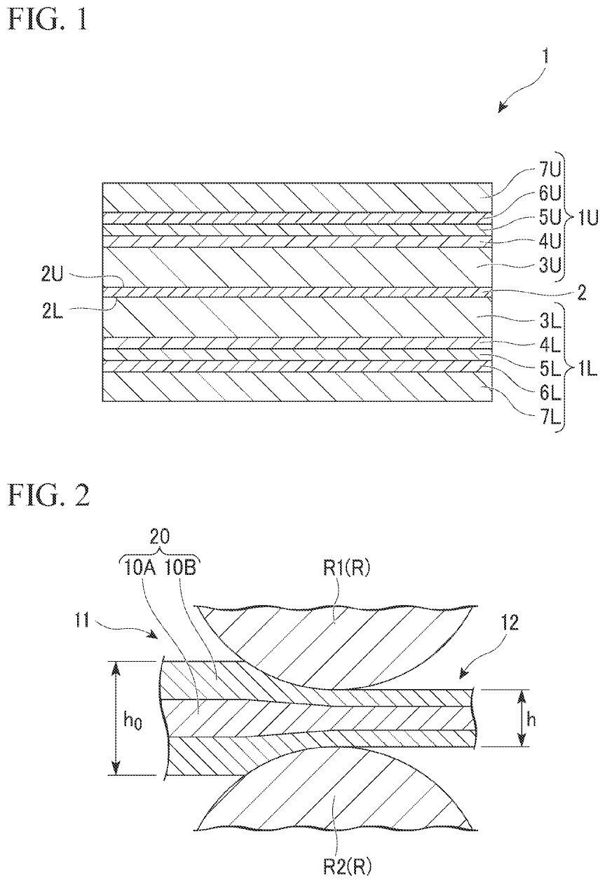

As shown in FIG. 1, an all solid-state secondary battery 1 has a positive electrode current collector 2, positive electrode layers 3U and 3L, electrolyte layers 4U and 4L, intermediate layers 5U and 5L, negative electrode layers 6U and 6L, and negative electrode current collectors 7U and 7L.

The positive electrode current collector 2 has a first surface 2U, and a second surface 2L opposite to the first surface 2U.

In a direction from the positive electrode current collector 2 toward the negative electrode current collector 7U, the positive electrode layer 3U, the electrolyte layer 4U, the intermediate layer 5U, the negative electrode layer 6U, and the negative electrode current collector 7U are laminated on the first surface 2U in sequence. The positive electrode layer 3U, the electrolyte layer 4U, the intermediate layer 5U, the negative electrode layer 6U, and the negative electrode current collector 7U are compressed against the positive electrode current collector 2 to configure a lamination compression structure 1U.

In a direction from the positive electrode current collector 2 toward the negative electrode current collector 7L, the positive electrode layer 3L, the electrolyte layer 4L, the intermediate layer 5L, the negative electrode layer 6L, and the negative electrode current collector 7L are laminated on the second surface 2L in sequence. The positive electrode layer 3L, the electrolyte layer 4L, the intermediate layer 5L, the negative electrode layer 6L, and the negative electrode current collector 7L are compressed against the positive electrode current collector 2 to configure a lamination compression structure 1L.

### <Positive Electrode Current Collector>

The positive electrode current collector 2 is a layer that is in contact with the positive electrode layers 3U and 3L. A material that configures the positive electrode current collector 2 is not particularly limited, and a known material usable as a positive electrode current collector of a solid secondary battery can be used in the positive electrode current collector 2. As the positive electrode current collector 2, for example, a metal foil such as a stainless steel (SUS) foil, an aluminum (Al) foil, or the like, is exemplified.

### <Positive Electrode Layer>

The positive electrode layers 3U and 3L are layers that are in contact with the electrolyte layers 4U and 4L, respectively. Each of the positive electrode layers 3U and 3L is a layer containing a positive electrode active material. The positive electrode active material is not particularly limited and a known material may be used as the positive electrode active material of the solid secondary battery. As the positive electrode active material, for example, a ternary system positive electrode material such as LiCoO₂, LiNiO₂, NCM (Li(NiₓCo_{y}Mn_{z}) O₂, (0<x<1, 0<y<1, 0<z<1, x+y+z=1)), or the like, a layered positive electrode active material particle such as LiVO₂, LiCrO₂, or the like, a spinel type positive electrode active material such as LiMn₂O₄, Li(Ni_{0.25}Mn_{0.75})₂O₄, LiCoMnO₄, Li₂NiMn₃O₈, or the like, or an olivine type positive electrode active material such as LiCoPO₄, LiMnPO₄, LiFePO₄, or the like, may be used.

Each of the positive electrode layers 3U and 3L may further contain a solid electrolyte, a conductive assistant, a binder, or the like, in addition to the positive electrode active material. The solid electrolyte, the conductive assistant, the binder, or the like, is not particularly limited and known materials can be applied as the electrode material of the solid secondary battery. The adhesive agent layer may be laminated on outer surfaces of the positive electrode layers 3U and 3L.

### <Electrolyte Layer>

The electrolyte layers 4U and 4L are layers that are in contact with the intermediate layers 5U and 5L, respectively. Each of the electrolyte layers 4U and 4L is a layer containing solid electrolyte. The electrolyte layers 4U and 4L may contain binder or the like, in addition thereto.

The type of the solid electrolyte is not particularly limited, and sulfide-based solid electrolyte, oxide-based solid electrolyte, nitride-based solid electrolyte, halide-based solid electrolyte, or the like, is exemplified as the solid electrolyte.

A material of the binder is not particularly limited, and, for example, polyvinylidene fluoride (PVdF), polymethyl methacrylate (PMMA), polyisobutene (PIB), styrene butadiene rubber (SBR), polyethylene-vinyl acetate copolymer (PEVA), nitrile rubber (NBR), hydrogenated nitrile rubber (HNBR), or the like, may be exemplified as the material of the binder. These may be used alone or in combination of two or more.

### <Intermediate Layer>

The intermediate layers 5U and 5L are layers that are in contact with the negative electrode layers 6U and 6L, respectively. As a material of the intermediate layers 5U and 5L, for example, a solid electrolyte, a carbide, and a binder are exemplified. As the carbide, for example, SnC may be used.

The intermediate layer 5U has at least one of a function of increasing ion conductivity between the electrolyte layer 4U and the negative electrode layer 6U corresponding to each other, and a function of protecting a surface of the negative electrode layer 6U.

Similarly, the intermediate layer 5L has at least one of a function of increasing ion conductivity between the electrolyte layer 4L and the negative electrode layer 6L corresponding to each other, and a function of protecting a surface of the negative electrode layer 6L.

### <Negative Electrode Layer>

The negative electrode layers 6U and 6L are layers that are in contact with the negative electrode current collectors 7U and 7L, respectively. Each of the negative electrode layers 6U and 6L is a layer containing a negative electrode active material. The negative electrode active material is not particularly limited, and a known material may be used as the negative electrode active material of the solid secondary battery. As the negative electrode active material, for example, lithium transition metal oxide such as lithium titanate (Li₄Ti₅O₁₂) or the like, transition metal oxide such as TiO₂, Nb₂O₃, WO₃, or the like, metal sulfide, metal nitride, a carbon material such as, graphite, soft carbon, hard carbon, or the like, a silicon-based material such as silicon single substance, silicon alloy, silicon compound, or the like, and lithium metal, lithium alloy, metal indium, or the like are exemplified.

Each of the negative electrode layers 6U and 6L may further include a solid electrolyte, a conductive assistant, a binder, or the like, in addition to the negative electrode active material. The solid electrolyte, the conductive assistant, the binder, or the like, is not particularly limited, and a known material may be applied as the electrode material of the solid secondary battery.

### <Negative Electrode Current Collector>

Each of the negative electrode current collectors 7U and 7L corresponds to the outermost layer of the all solid-state secondary battery 1. In other words, the negative electrode current collector 7U corresponds to the outermost layer of the lamination compression structure 1U. The negative electrode current collector 7L corresponds to the outermost layer of the lamination compression structure 1L.

A material of the negative electrode current collectors 7U and 7L is not particularly limited, and a known material may be used as the negative electrode current collector of the solid secondary battery. As the negative electrode current collector, metal foil such as copper (Cu) foil, stainless steel (SUS) foil, aluminum (Al) foil, or the like, is exemplified.

### <Method of Manufacturing all Solid-State Secondary Battery According to First Embodiment>

Next, the method of manufacturing the all solid-state secondary battery 1 according to the first embodiment will be described with reference to FIG. 1 to FIG. 5.

The method of manufacturing the all solid-state secondary battery 1 has the following processes.
Step 1: Positive electrode layer forming process
Step 2: First compression process
Step 3: Electrolyte layer laminating process
Step 4: Second compression process
Step 5: Intermediate layer laminating process
Step 6: Third compression process
Step 7: Integrating process
Step 8: Fourth compression process

Further, in the method of manufacturing the all solid-state secondary battery 1, steps 1 to 8 are performed in sequence. Further, in the first compression process, the second compression process, the third compression process, and the fourth compression process, a known compression process is performed. As an example of the compression process, in the embodiment, a roll press method is employed.

### <Roll Press Apparatus>

FIG. 2 is a cross-sectional view showing a part of a roll press apparatus configured to perform a roll press method.

The roll press apparatus has a first roll R1 and a second roll R2, which face each other, and a delivery mechanism (not shown). The first roll R1 is rotatable counterclockwise. The second roll R2 is rotatable clockwise. The delivery mechanism can send a compression object 20 to a gap between the first roll R1 and the second roll R2 in a direction from an insertion portion 11 toward a discharge portion 12. A distance between the first roll R1 and the second roll R2 can be adjusted as appropriate. In addition, the roll press apparatus can adjust a compressive force added to the compression object 20 as appropriate. In the following description, when the first roll R1 and the second roll R2 are not discriminated, the first roll R1 and the second roll R2 may be simply referred to as “a roll R.”

Each of the first roll R1 and the second roll R2 is an example of a compression member configured to compress a compression object.

### <Roll Press Method>

The compression object 20 is a laminated body having a first layer 10A and a second layer 10B. In a state before compression, the compression object 20 has a thickness h0. First, the delivery mechanism sends the compression object 20 to a gap between the first roll R1 and the second roll R2 through the insertion portion 11. According to rotation of the first roll R1 and the second roll R2, the compression object 20 moves from the insertion portion 11 toward the discharge portion 12. The compression object 20 is compressed by the first roll R1 and the second roll R2, and a thickness of the compression object 20 is gradually reduced. A thickness of each of the first layer 10A and the second layer 10B that constitute the compression object 20 is gradually reduced. In a state after compression, the compression object 20 has a thickness h smaller than the thickness h0.

Next, each of steps 1 to 8 will be described.

### <Step 1: Positive Electrode Layer Forming Process>

First, the positive electrode current collector 2, and the positive electrode layers 3U and 3L are prepared.

Next, the positive electrode layer 3U is laminated on the first surface 2U of the positive electrode current collector 2. The positive electrode layer 3L is laminated on the second surface 2L of the positive electrode current collector 2. Accordingly, a laminated body is obtained by laminating the positive electrode current collector 2 and the positive electrode layers 3U and 3L.

Further, the positive electrode layer forming process is not limited to a method of directly laminating the positive electrode layers 3U and 3L on the positive electrode current collector 2. The positive electrode layers 3U and 3L that are formed separately may be transferred to the positive electrode current collector 2 in advance.

### <Step 2: First Compression Process>

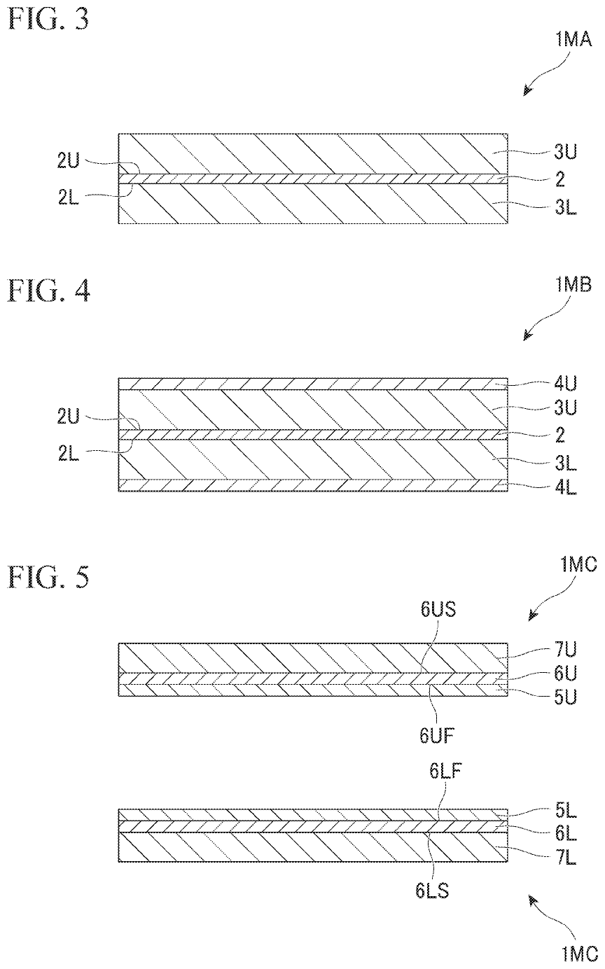

Next, the laminated body obtained by the electrolyte layer laminating process is compressed using the roll press apparatus shown in FIG. 2. Specifically, as the compression object 20, the laminated body obtained by the electrolyte layer laminating process is inserted between the first roll R1 and the second roll R2. According to rotation of the first roll R1 and the second roll R2, the laminated body is gradually compressed. Accordingly, a first compressed body 1MA shown in FIG. 3 is obtained. In the first compression process, a pressure (first pressure) applied to the laminated body by the first roll R1 and the second roll R2 is, for example, 500 MPa.

### <Step 3: Electrolyte Layer Laminating Process>

Next, the electrolyte layers 4U and 4L are prepared.

Next, the electrolyte layer 4U is laminated on a surface of the first compressed body 1MA in which the positive electrode layer 3U is exposed. The electrolyte layer 4L is laminated on a surface of the first compressed body 1MA in which the positive electrode layer 3L is exposed. Accordingly, a laminated body is obtained by laminating the positive electrode current collector 2, the positive electrode layers 3U and 3L, and the electrolyte layers 4U and 4L.

Further, in the electrolyte layer laminating process, there is no limitation of a method of directly laminating the electrolyte layers 4U and 4L on the positive electrode layers 3U and 3L. The electrolyte layers 4U and 4L that are formed separately may be transferred to the positive electrode layers 3U and 3L in advance.

### <Step 4: Second Compression Process>

Next, the laminated body obtained by the electrolyte layer laminating process is compressed using the roll press apparatus shown in FIG. 2. Specifically, as the compression object 20, the laminated body obtained by the electrolyte layer laminating process is inserted between the first roll R1 and the second roll R2. According to rotation of the first roll R1 and the second roll R2, the laminated body is gradually compressed. Accordingly, a second compressed body 1MB shown in FIG. 4 is obtained. In the second compression process, a pressure (second pressure) applied to the laminated body by the first roll R1 and the second roll R2 is, for example, 900 MPa to 1000 MPa. Accordingly, in comparison of the first pressure and the second pressure, the second pressure is set to be higher than the first pressure.

### <Step 5: Intermediate Layer Laminating Process>

Next, the intermediate layers 5U and 5L, the negative electrode layers 6U and 6L, and the negative electrode current collectors 7U and 7L are prepared. The negative electrode layer 6U has a first negative electrode surface 6UF, and a second negative electrode surface 6US opposite to the first negative electrode surface 6UF. The negative electrode layer 6L has a first negative electrode surface 6LF, and a second negative electrode surface 6LS opposite to the first negative electrode surface 6LF. The intermediate layer 5U is laminated on the first negative electrode surface 6UF. The negative electrode current collector 7U is laminated on the second negative electrode surface 6US. The intermediate layer 5L is laminated on the first negative electrode surface 6LF. The negative electrode current collector 7L is laminated on the second negative electrode surface 6LS.

Accordingly, a laminated body is obtained by laminating the intermediate layer 5U, the negative electrode layer 6U, and the negative electrode current collector 7U in sequence. Further, a laminated body is obtained by laminating the intermediate layer 5L, the negative electrode layer 6L, and the negative electrode current collector 7L in sequence.

### <Step 6: Third Compression Process>

Next, each of two laminated bodies obtained by the intermediate layer laminating process is compressed using the roll press apparatus shown in FIG. 2. Specifically, as the compression object 20, each of the two laminated bodies obtained by the intermediate layer laminating process is inserted between the first roll R1 and the second roll R2. According to rotation of the first roll R1 and the second roll R2, the laminated body is gradually compressed. Accordingly, two third compressed bodies 1MC shown in FIG. 5 are obtained. In the third compression process, a pressure (third pressure) applied to the laminated body by the first roll R1 and the second roll R2 is, for example, 300 MPa to 400 MPa, or 400 MPa or more. Accordingly, in comparison of the second pressure and the third pressure, the second pressure is set to be higher than the third pressure.

### <Step 7: Integrating Process>

An integrated member is obtained by integrating the second compressed body 1MB and two of the third compressed bodies 1MC such that the electrolyte layers 4U and 4L of the second compressed body 1MB face the intermediate layers 5U and 5L of the third compressed bodies 1MC, respectively. Specifically, the second compressed body 1MB and two of the third compressed bodies 1MC are integrated such that the two third compressed bodies 1MC sandwich the second compressed body 1MB.

### <Step 8: Fourth Compression Process>

Next, the integrated member obtained by the integrating process is compressed using the roll press apparatus shown in FIG. 2. Specifically, as the compression object 20, the integrated member is inserted between the first roll R1 and the second roll R2. According to rotation of the first roll R1 and the second roll R2, the integrated member is gradually compressed. Accordingly, the all solid-state secondary battery 1 shown in FIG. 1 is obtained. In the fourth compression process, a pressure (fourth pressure) applied to the laminated body by the first roll R1 and the second roll R2 is, for example, 200 MPa or less. Accordingly, in comparison of the second pressure and the fourth pressure, the second pressure is set to be higher than the fourth pressure.

Describing a first pressure in the first compression process, a second pressure in the second compression process, a third pressure in the third compression process, and a fourth pressure in the fourth compression process, the second pressure is higher than each of the first pressure, the third pressure, and the fourth pressure. More preferably, the first pressure to the fourth pressure are preferably set to obtain a pressure relation of “fourth pressure<third pressure<first pressure<second pressure.”

### <Effects>

According to this method, by performing the first compression process, the positive electrode layers 3U and 3L can be preliminarily compressed. The first pressure in the first compression process is about 500 MPa, which is lower than the second pressure. For this reason, the first compression process can be performed with a low pressure, and each of the positive electrode layers 3U and 3L is prevented from becoming too hard. Accordingly, a bonding property of the electrolyte layers 4U and 4L to each of the positive electrode layers 3U and 3L can be increased.

Further, by performing the first compression process, it is possible to promote alignment of particles that configure the positive electrode layers 3U and 3L. For this reason, it is possible to easily stabilize a positive electrode density in the positive electrode layers 3U and 3L.

By performing the second compression process, it is possible to increase densities of the positive electrode layers 3U and 3L while improving bonding properties of the positive electrode layers 3U and 3L and the electrolyte layers 4U and 4L.

By performing the third compression process, it is possible to densify the intermediate layers 5U and 5L while suppressing damage to the negative electrode layers 6U and 6L. A layer that constitutes each of the negative electrode layers 6U and 6L is a thin film. The thin film that constitutes each of the negative electrode layers 6U and 6L is, for example, a Li foil or the like. According to the third compression process, damage to the thin films in the negative electrode layers 6U and 6L can be suppressed.

By performing the fourth compression process, the second compressed body 1MB and the third compressed bodies 1MC that constitute the integrated member can be bonded to each other.

The first pressure in the fourth compression process is about 200 MPa or less, which is lower than the second pressure. For this reason, the fourth compression process can be performed at a lower pressure, and deformation of the positive electrode layers 3U and 3L can be suppressed.

Further, since smoothness in the interface between the electrolyte layers 4U and 4L and the intermediate layers 5U and 5L is improved, it is possible to realize the all solid-state secondary battery 1 with excellent homogeneity.

Further, the positive electrode layer 3U is formed on the first surface 2U of the positive electrode current collector. Similarly, the positive electrode layer 3U is formed on the second surface 2L of the positive electrode current collector. That is, a structure in which the positive electrode layers 3U and 3L are formed on both surfaces of the positive electrode current collector is obtained. In such a structure, even after the first compression process, the second compression process, the third compression process, and the fourth compression process are performed, a restoring force of the positive electrode layers 3U and 3L generated in the first surface 2U and a restoring force of the positive electrode layers 3U and 3L generated in the second surface 2L cancel each other out. Accordingly, in the entire all solid-state secondary battery 1, occurrence of warpage is suppressed. For this reason, flatness of the all solid-state secondary battery 1 can be improved. In particular, in the first compression process, the second compression process, the third compression process, and the fourth compression process, when the roll press method is used, a difference in frictional coefficient between a surface of the roll and a surface of the laminated body laminated on both surfaces of the positive electrode current collector can be reduced. Accordingly, flatness of the all solid-state secondary battery 1 can be improved.

In general, the electrolyte layer is composed of powder. For this reason, in the structure configured to directly bond the negative electrode layers 6U and 6L to the electrolyte layer, a bonding property of the negative electrode layer with respect to the electrolyte layer is low. On the other hand, in the method of manufacturing the all solid-state secondary battery 1 according to the aspect of the present invention, the intermediate layers 5U and 5L are interposed between the negative electrode layers 6U and 6L and the electrolyte layers 4U and 4L, and the intermediate layers 5U and 5L has a solid electrolyte, a carbide, and a binder.

Accordingly, in comparison with the structure in which the electrolyte layers 4U and 4L are directly bonded to the negative electrode layers 6U and 6L, in the structure including the intermediate layers 5U and 5L, a bonding property of the negative electrode layers 6U and 6L to the electrolyte layers 4U and 4L can be increased.

Further, the intermediate layers 5U and 5L are compressed at the third pressure lower than the second pressure, and compressed at the fourth pressure lower than the second pressure. For this reason, it is possible to suppress segregation in particles that constitute the solid electrolyte, the carbide, and the binder contained in the intermediate layers 5U and 5L.

Further, each of the third compression process and the fourth compression process is performed in a state in which the second negative electrode surface 6US of the negative electrode layer 6U is covered with the negative electrode current collector 7U. Similarly, each of the third compression process and the fourth compression process is performed in a state in which the second negative electrode surface 6LS of the negative electrode layer 6L is covered with the negative electrode current collector 7L. In this case, the roll R does not contact each of the negative electrode layers 6U and 6L. Accordingly, damage to the negative electrode layers 6U and 6L can be suppressed.

### <Variant 1 of First Embodiment>

The electrolyte layers 4U and 4L may have porous substrates. The porous substrate may have a uniform surface with respect to a surface of each of the positive electrode layers 3U and 3L or a surface of each of the intermediate layers 5U and 5L. As a material that configures the porous substrate, for example, polymer, ceramics, metal, non-woven fabric, or the like, is exemplified. According to the material having a three-dimensional frame, a material of the porous substrate is not limited.

As a comparative example, a case of compressing the electrolyte layer at the second pressure in the second compression process is considered. Since the second pressure is a high pressure such as 900 MPa to 1000 MPa, it is difficult to deform the electrolyte layer and maintain dimensional accuracy of the electrolyte layer. On the other hand, in the configuration in which the electrolyte layers 4U and 4L have the porous substrates, even when the electrolyte layer is compressed at the second pressure in the second compression process, dimensional accuracy of the electrolyte layers 4U and 4L can be maintained. In particular, even when the thickness of each of the electrolyte layers 4U and 4L is small, dimensional accuracy of the electrolyte layers 4U and 4L can be maintained.

### <Variant 2 of First Embodiment>

Timing when the positive electrode layer forming process, the first compression process, the electrolyte layer laminating process, and the second compression process are performed and timing when the intermediate layer laminating process and the third compression process are performed are not limited to the above-mentioned first embodiment. The reason for this is that a treatment process of the positive electrode current collector 2, the positive electrode layers 3U and 3L, and the electrolyte layers 4U and 4L in the positive electrode layer forming process, the first compression process, the electrolyte layer laminating process, and the second compression process is independent from a treatment process of the intermediate layers 5U and 5L, the negative electrode layers 6U and 6L, and the negative electrode current collectors 7U and 7L in the intermediate layer laminating process and the third compression process.

Accordingly, the intermediate layer laminating process and the third compression process may be performed while the positive electrode layer forming process, the first compression process, the electrolyte layer laminating process, and the second compression process are performed. Alternatively, after the intermediate layer laminating process and the third compression process are performed, the positive electrode layer forming process, the first compression process, electrolyte layer laminating process, and the second compression process may be performed.

### Second Embodiment

Next, an all solid-state secondary battery 21 according to a second embodiment will be described.

The second embodiment is distinguished from the first embodiment in the configuration of the electrolyte layer.

In the second embodiment, the same members as in the first embodiment are designated by the same reference signs, and descriptions thereof will be omitted or simplified.

### <Configuration of all Solid-State Secondary Battery>

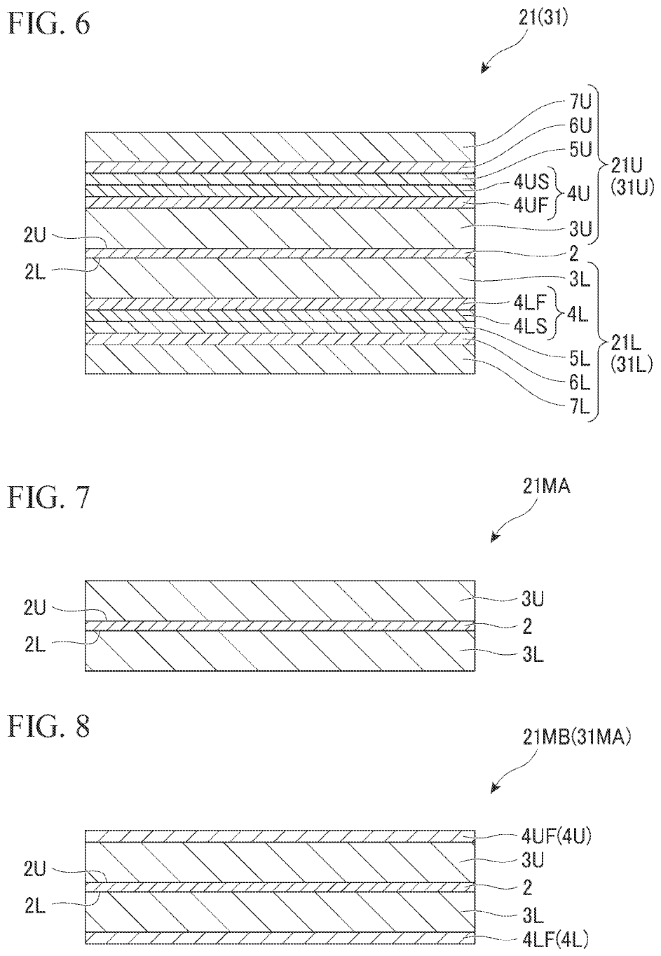

As shown in FIG. 6, the all solid-state secondary battery 21 has a positive electrode current collector 2, positive electrode layers 3U and 3L, first electrolyte layers 4UF and 4LF, second electrolyte layers 4US and 4LS, intermediate layers 5U and 5L, negative electrode layers 6U and 6L, and negative electrode current collectors 7U and 7L.

### <First Electrolyte Layer>

The first electrolyte layer 4UF has the same configuration as that of the above-mentioned the electrolyte layer 4U. Similarly, the first electrolyte layer 4LF has the same configuration as that of the above-mentioned electrolyte layer 4L. For this reason, in FIG. 6, reference signs 4U and 4L are written together.

### <Second Electrolyte Layer>

The second electrolyte layers 4US and 4LS are examples of the thin film electrolyte layer.

A material that forms the second electrolyte layers 4US and 4LS may be the same as in the electrolyte layers 4U and 4L. As a variant, a content of the binder contained in the first electrolyte layers 4UF and 4LF may be greater than that of the binder contained in the second electrolyte layers 4US and 4LS.

A thickness of the second electrolyte layer 4US is smaller than that of the first electrolyte layer 4UF.

A thickness of the second electrolyte layer 4LS is smaller than that of the first electrolyte layer 4LF.

Since a material that forms the second electrolyte layers 4US and 4LS is the same as that of the electrolyte layers 4U and 4L, in FIG. 6, reference signs 4U and 4L are written together.

### <Method of Manufacturing all Solid-State Secondary Battery According to Second Embodiment>

Next, a method of manufacturing the all solid-state secondary battery 21 according to the second embodiment will be described.

First, a positive electrode layer forming process and a first compression process are performed. Accordingly, a first compressed body 21MA shown in FIG. 7 is obtained. Next, an electrolyte layer laminating process and a second compression process are performed. Accordingly, a second compressed body 21MB shown in FIG. 8 is obtained. The second compressed body 21MB has the first electrolyte layers 4UF and 4LF.

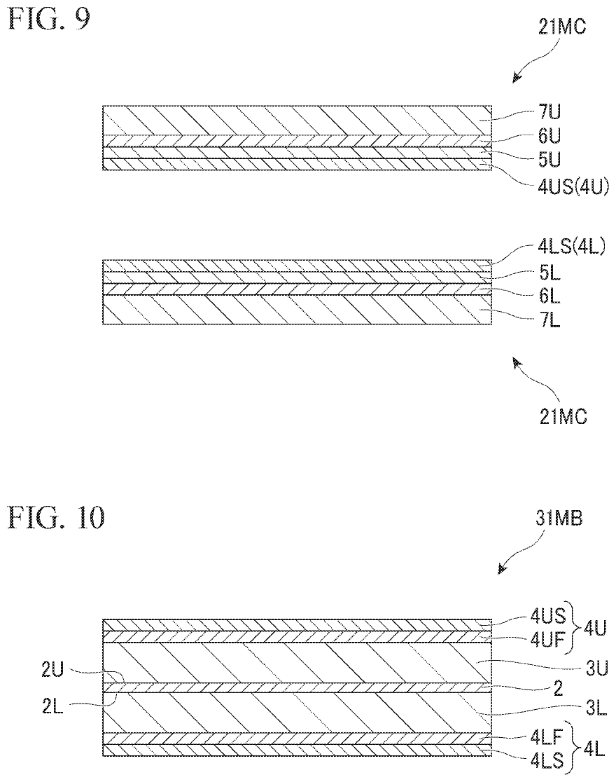

Next, an intermediate layer laminating process and a third compression process are performed. Accordingly, two of the third compressed bodies 21MC shown in FIG. 9 are obtained. After the third compression process is performed, the second electrolyte layer 4US is laminated on a surface of the third compressed bodies 21MC in which the intermediate layer 5U is exposed. Similarly, the second electrolyte layer 4LS is laminated on a surface of the third compressed bodies 21MC in which the intermediate layer 5L is exposed.

Next, the integrating process is performed. Accordingly, the second compressed body 21MB and two of the third compressed bodies 21MC are integrated to sandwich the second electrolyte layers 4US and 4LS.

Next, in the fourth compression process, the integrated member obtained by the integrating process is compressed. Accordingly, the all solid-state secondary battery 21 shown in FIG. 6 is obtained.

### <Effects>

According to this method, the same or similar effect as that obtained by the above-mentioned first embodiment can be obtained. Further, before the fourth compression process is performed, an uneven shape of the second electrolyte layers 4US and 4LS can be maintained, and a low density state can be maintained. Further, the second electrolyte layers 4US and 4LS can function as an adhesive agent that makes the second compressed body 21MB and two of the third compressed bodies 21MC adhere each other in the fourth compression process.

### Third Embodiment

Next, an all solid-state secondary battery 31 according to a third embodiment will be described.

A structure of the all solid-state secondary battery 31 is the same as that of the all solid-state secondary battery 21 according to the second embodiment.

In the third embodiment, the same members as in the first embodiment and the second embodiment are designated by the same reference signs, and descriptions thereof will be omitted or simplified.

### <Method of Manufacturing all Solid-State Secondary Battery According to Third Embodiment>

Next, a method of manufacturing the all solid-state secondary battery 31 according to the third embodiment will be described.

First, the positive electrode layer forming process, the first compression process, the electrolyte layer laminating process, and the second compression process are performed. Accordingly, a second compressed body 31MB shown in FIG. 10 is obtained. The second compressed body 31MB has the first electrolyte layers 4UF and 4LF.

Next, after the second compression process is performed, the second electrolyte layer 4US is laminated on a surface of the second compressed body 31MB in which the first electrolyte layer 4UF is exposed, and the second electrolyte layer 4LS is laminated on a surface in which the first electrolyte layer 4LF is exposed.

Next, the intermediate layer laminating process and the third compression process are performed. Accordingly, two of the third compressed bodies 31MC shown in FIG. 11 are obtained.

Next, the integrating process is performed. Accordingly, the second compressed body 31MB and the two third compressed bodies 31MC are integrated to sandwich the second electrolyte layers 4US and 4LS.

Next, in the fourth compression process, the integrated member obtained by the integrating process is compressed. Accordingly, the all solid-state secondary battery 31 shown in FIG. 6 is obtained.

### <Effects>

According to this method, the same or similar effect as that obtained by the above-mentioned first embodiment is obtained. Further, before the fourth compression process is performed, an uneven shape of the second electrolyte layers 4US and 4LS can be maintained, and a low density state can be maintained. Further, the second electrolyte layers 4US and 4LS can function as an adhesive agent that makes the second compressed body 31MB and the two third compressed bodies 31MC adhere each other in the fourth compression process.

### Fourth Embodiment

Next, an all solid-state secondary battery according to a fourth embodiment will be described.

The fourth embodiment is distinguished from the first embodiment in configurations of the negative electrode layers 6U and 6L and the negative electrode current collectors 7U and 7L.

In the fourth embodiment, the same members as in the first embodiment are designated by the same reference signs, and descriptions thereof will be omitted or simplified.

### <Negative Electrode Layer>

In the fourth embodiment, each of the negative electrode layers 6U and 6L includes both a function of the negative electrode layer and a function of the negative electrode current collector. Each of the negative electrode layers 6U and 6L corresponds to the outermost layer of the all solid-state secondary battery 21. In other words, the negative electrode layer 6U corresponds to the outermost layer of the lamination compression structure 1U. The negative electrode layer 6L corresponds to the outermost layer of the lamination compression structure 1L.

Each of the negative electrode layers 6U and 6L has a structure in which the negative electrode active material layer and the negative electrode current collecting layer are laminated. The negative electrode active material layer contains the negative electrode active material described in the first embodiment. The negative electrode current collecting layer is a metal foil such as a copper (Cu) foil, a stainless steel (SUS) foil, an aluminum (Al) foil, or the like.

### <Effects>

According to this method, each of the negative electrode layers 6U and 6L is a laminated body of the negative electrode active material layer and the negative electrode current collecting layer. For this reason, there is no need to prepare the negative electrode current collectors 7U and 7L described in the intermediate layer laminating process. Accordingly, the number of processings for manufacturing the all solid-state secondary battery can be reduced.

### Fifth Embodiment

Next, a method of manufacturing an all solid-state secondary battery according to a fifth embodiment will be described.

The fifth embodiment is distinguished from each of the above-mentioned first to fourth embodiments in that a protective sheet is interposed between the compression object 20 and the roll R.

In the fifth embodiment, the same members as in the first to fourth embodiments are designated by the same reference signs, and descriptions thereof will be omitted or simplified.

### <Protective Sheet>

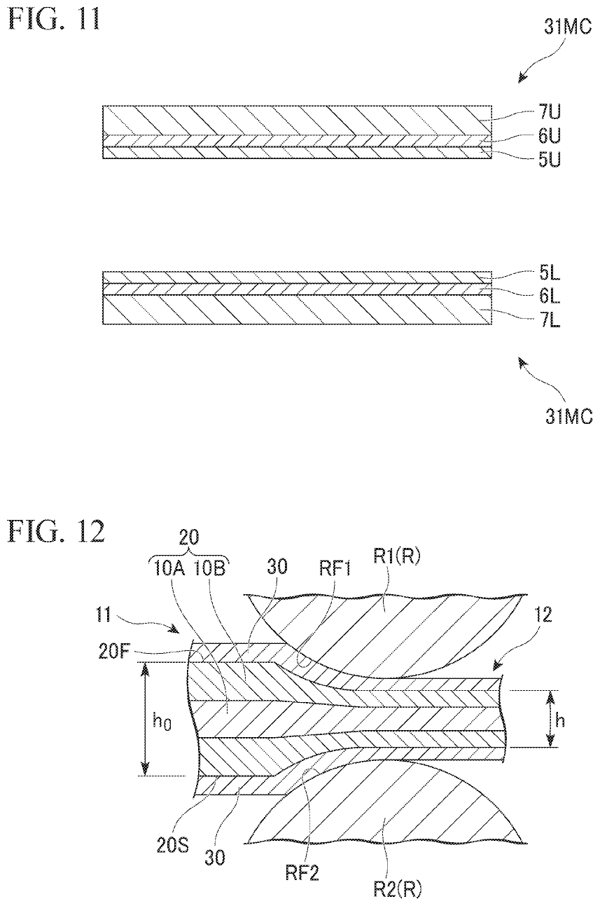

In at least one of the first compression process, the second compression process, the third compression process, and the fourth compression process, as shown in FIG. 12, a protective sheet 30 is interposed between the compression object 20 and the first roll R1. In other words, the protective sheet 30 is interposed between a first compression surface RF1 of the first roll R1 and a first compression object surface 20F of the compression object 20. Similarly, the protective sheet 30 is interposed between the compression object 20 and the second roll R2. In other words, the protective sheet 30 is interposed between a second compression surface RF2 of the second roll R2 and a second compression object surface 20S of the compression object 20.

In this state, the first roll R1 and the second roll R2 compress the compression object 20 while rotating.

In the method of manufacturing an all solid-state secondary battery according to the above-mentioned embodiment, the protective sheet 30 can be interposed between the positive electrode current collector 2 and the roll R. The protective sheet 30 can be interposed between each of the negative electrode layers 6U and 6L and the roll R. In addition, the protective sheet 30 can be interposed between each of the negative electrode current collectors 7U and 7L and the roll R.

The protective sheet 30 is separate from each of the positive electrode current collector 2, the negative electrode layers 6U and 6L, and the negative electrode current collectors 7U and 7L. In other words, the protective sheet 30 is a member that does not constitute the all solid-state secondary battery. For this reason, the protective sheet 30 is removed from the compression object 20 after each of the plurality of compression processes is terminated. Further, the protective sheet 30 may remain covering the compression object 20 until the next compression process is performed after one compression process is terminated.

Further, in the example shown in FIG. 12, while the protective sheets 30 are disposed on both surfaces of the compression object 20, the protective sheet 30 may be disposed at least one surface of the compression object 20.

As the material of the protective sheet 30, for example, a metal foil or a resin film is employed. As the metal foil, for example, a copper (Cu) foil, a stainless steel (SUS) foil, an aluminum (Al) foil, or the like, is exemplified. As the resin film, polyimide, polyether imide, fluororesin, or the like, is exemplified. A thickness of the protective sheet 30 is within a range of, for example, 5 to 150 μm.

### <Effects>

According to this method, the same or similar effects as those obtained by the above-mentioned embodiment are obtained. In at least one of the first compression process, the second compression process, the third compression process, and the fourth compression process, even when the pressure is added to the positive electrode current collector 2, the negative electrode layers 6U and 6L, and the negative electrode current collectors 7U and 7L, since the protective sheet 30 is used, damage to the positive electrode current collector 2, the negative electrode layers 6U and 6L, and the negative electrode current collectors 7U and 7L can be suppressed. In particular, when the positive electrode current collector 2, the negative electrode layers 6U and 6L, and the negative electrode current collectors 7U and 7L are formed of a thin foil-shaped material, it is possible to obtain an effect of suppressing damage to the positive electrode current collector 2, the negative electrode layers 6U and 6L, and the negative electrode current collectors 7U and 7L.

### <Variant>

In the above-mentioned embodiment, the case in which the lamination compression structures 1U and 1L are formed on the first surface 2U and the second surface 2L of the positive electrode current collector 2, respectively, has been described. The lamination compression structure may be formed on only one surface of the positive electrode current collector 2.

In the above-mentioned embodiment, the case in which the roll press method is used as an example of the compression process has been described. A compression method other than the roll press method may be employed as long as the compression object 20 can be compressed using the compression member.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A method of manufacturing an all solid-state secondary battery, the method comprising:
a positive electrode layer forming process of forming a positive electrode layer containing a positive electrode active material;
a first compression process of compressing the positive electrode layer with a first pressure and obtaining a first compressed body;
an electrolyte layer laminating process of laminating an electrolyte layer containing a solid electrolyte on a surface of the first compressed body in which the positive electrode layer is exposed;
a second compression process of compressing the positive electrode layer and the electrolyte layer with a second pressure and obtaining a second compressed body;
an intermediate layer laminating process of preparing a negative electrode layer and an intermediate layer and laminating the intermediate layer on the negative electrode layer;
a third compression process of compressing the negative electrode layer and the intermediate layer with a third pressure and obtaining a third compressed body;
an integrating process of obtaining an integrated member by integrating the second compressed body and the third compressed body such that the electrolyte layer of the second compressed body faces the intermediate layer of the third compressed body; and
a fourth compression process of compressing the integrated member with a fourth pressure,
wherein the second pressure is higher than each of the first pressure, the third pressure, and the fourth pressure.

2. The method of manufacturing an all solid-state secondary battery according to claim 1, wherein, in the positive electrode layer forming process,
a positive electrode current collector having a first surface and a second surface opposite to the first surface is prepared, and
the positive electrode layer is formed on each of the first surface and the second surface.

3. The method of manufacturing an all solid-state secondary battery according to claim 1, wherein the intermediate layer has a solid electrolyte, a carbide, and a binder.

4. The method of manufacturing an all solid-state secondary battery according to claim 1, wherein, in each of the first compression process, the second compression process, the third compression process, and the fourth compression process, a compression member configured to compress a compression object is used, and
in at least one of the first compression process, the second compression process, the third compression process, and the fourth compression process, the compression member compresses the compression object in a state in which a protective sheet is interposed between the compression object and the compression member.

5. The method of manufacturing an all solid-state secondary battery according to claim 1, preparing a thin film electrolyte layer which contains a solid electrolyte and which is thinner than the electrolyte layer,
after the third compression process is performed, the thin film electrolyte layer is laminated on a surface of the third compressed body in which the intermediate layer is exposed, and
in the integrating process, the integrated member is obtained by integrating the second compressed body and the third compressed body so as to sandwich the thin film electrolyte layer.

6. The method of manufacturing an all solid-state secondary battery according to claim 1, preparing a thin film electrolyte layer which contains a solid electrolyte and which is thinner than the electrolyte layer,
after the second compression process is performed, the thin film electrolyte layer is laminated on a surface of the second compressed body in which the electrolyte layer is exposed, and
in the integrating process, the integrated member is obtained by integrating the second compressed body and the third compressed body so as to sandwich the thin film electrolyte layer.

7. The method of manufacturing an all solid-state secondary battery according to claim 1, wherein the electrolyte layer has a porous substrate.
